(19) United States
(12) Patent Application Publication
(10) Pub. No.: US 2024/0259182 A1
(43) Pub. Date: Aug. 1, 2024

(54) Quantum Attack Resistant Advanced Encryption Standard (AES) Encryption

(71) Applicant: Intel Corporation, Santa Clara, CA (US)

(72) Inventor: Santosh Ghosh, Hillsboro, OR (US)

(73) Assignee: Intel Corporation, Santa Clara, CA (US)

(21) Appl. No.: 18/162,856

(22) Filed: Feb. 1, 2023

(51) Int. Cl. H04L 9/06

(52) U.S. Cl. CPC H04L 9/0631

(57) ABSTRACT

Techniques for implementing Advanced Encryption Standard (AES)-256 encryption. An implementation includes a time-shared round data path with a depth-2 pipeline that results in an atomic execution of two 14-round AES-256 encryption operations in 30 cycles while operating at the same high-frequency clock used for processing cores of a computing system. The technology described herein uses only two cycles of latency per round while supporting a very high maximum operating clock speed.

### BACKGROUND

Upcoming quantum computers are predicted to break traditional AES-128 encryption (e.g., encryption using keys having 128 bits) by using, for example, a quantum search algorithm such as Grover's algorithm. In response, widely used communications protocols (e.g., transport layer security (TLS), media access control security (MACSec), internet protocol security (IPSec), and others) must be upgraded with AES-256 to protect against potential quantum attacks. However, a typical implementation of AES-256 in a computing system inherently has an approximately 40% higher overhead compared to an AES-128 implementation. Further, high volume, data driven artificial intelligence (AI) applications require increasingly high bandwidth in secure communications. Thus, new approaches to AES-256 implementation are needed.

### BRIEF DESCRIPTION OF DRAWINGS

Various examples in accordance with the present disclosure will be described with reference to the drawings.

FIG. 1 is a block diagram of a computing system in one implementation.

FIG. 2 is a block diagram of an accelerator in one implementation.

FIG. 3 is a prior art example of AES-256 encryption circuitry.

FIG. 4 illustrates encryption circuitry in an implementation.

FIG. 5 illustrates encryption processing in an implementation.

FIG. 6 illustrates key expansion circuitry in an implementation.

FIG. 7 illustrates key expansion processing in an implementation.

FIG. 8 illustrates an exemplary system.

FIG. 9 illustrates a block diagram of an example processor that may have more than one core and an integrated memory controller.

FIG. 10(A) is a block diagram illustrating both an exemplary in-order pipeline and an exemplary register renaming, out-of-order issue/execution pipeline according to examples.

FIG. 10(B) is a block diagram illustrating both an exemplary example of an in-order architecture core and an exemplary register renaming, out-of-order issue/execution architecture core to be included in a processor according to examples.

FIG. 11 illustrates examples of execution unit(s) circuitry, such as the execution unit(s) circuitry of FIG. 10(B).

FIG. 12 is a block diagram of a register architecture according to some examples.

### DETAILED DESCRIPTION

The present disclosure relates to methods, apparatus, and systems to implement AES-256 encryption. An implementation includes a time-shared round data path with a depth-2 pipeline that results in an atomic execution of two 14-round AES-256 encryption operations in 30 cycles while operating at the same high-frequency clock used for processing cores of a computing system. The technology described herein uses only two cycles of latency per round while supporting a very high (e.g., up to 4.5 Giga Hertz (GHz) on a 10 nanometer (nm) processing core)) maximum operating clock speed. In an implementation, the encryption circuitry may be implemented in an accelerator tightly coupled with a processing core so that only a few load/store instructions are used to execute two 14-round AES-256 operations compared to 56 instructions using traditional AES new instructions (AES-NI) available in processors from Intel Corporation.

According to some examples, the technologies described herein may be implemented in one or more electronic devices. Non-limiting examples of electronic devices that may utilize the technologies described herein include any kind of computing system, mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, disaggregated server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide post-quantum encryption.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described but are not limited to such.

In addition, the various elements of combinatorial logic and sequential logic discussed in the present disclosure may pertain both to physical structures (such as AND gates, OR gates, or exclusive-OR (XOR) gates), or to synthesized or otherwise optimized collections of devices implementing the logical structures that are Boolean equivalents of the logic under discussion.

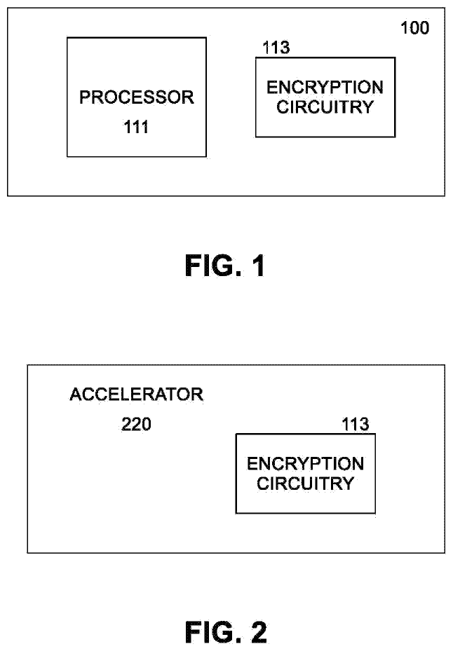

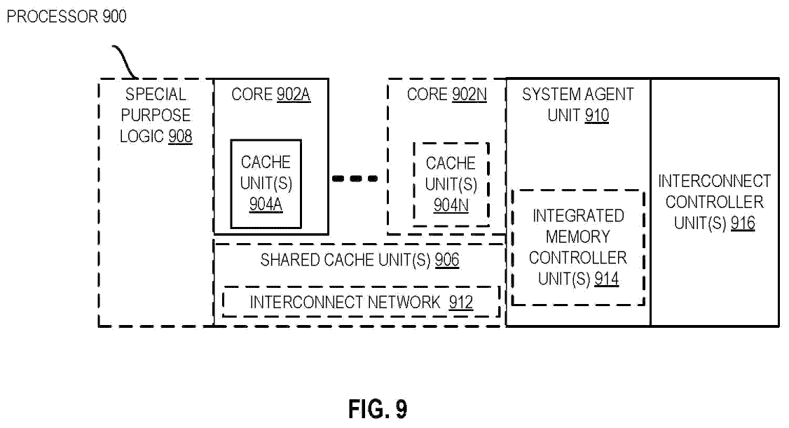

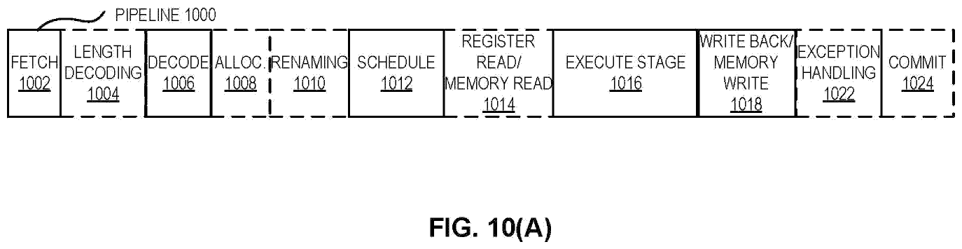

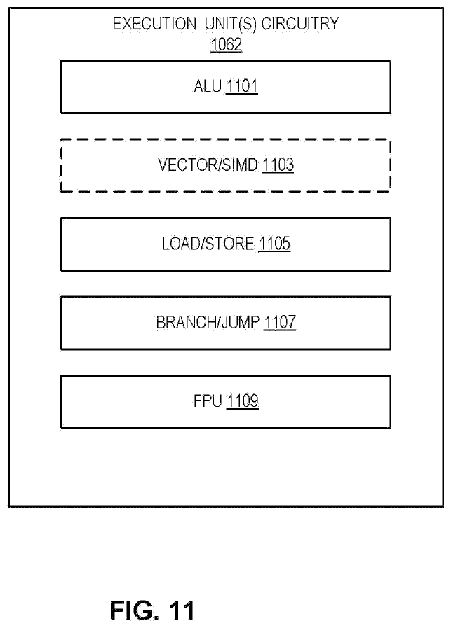

With reference to FIG. 1, an example of a computing system 100 may include a processor 111 to perform data processing operations, and encryption circuitry 113, coupled to processor 111, to perform encryption operations. For example, processor 111 may be implemented as any of the processors described below. Encryption circuitry 113 may also be incorporated in processor 111, such as processor 800, processor 870, processor 815, coprocessor 838, and/or processor/coprocessor 880 (FIG. 8), processor 900 (FIG. 9), core 890 (FIG. 8(B)), and execution units 1062 (FIGS. 8(B) and 11).

In an implementation, encryption circuitry 113 implements the AES-256 encryption as defined by “Advanced Encryption Standard” in Federal Information Processing Standards Publication (FIPS Pub) 197, Nov. 26, 2001. In other implementations, other encryption algorithms and keys with a number of bits other than 256 may be used.

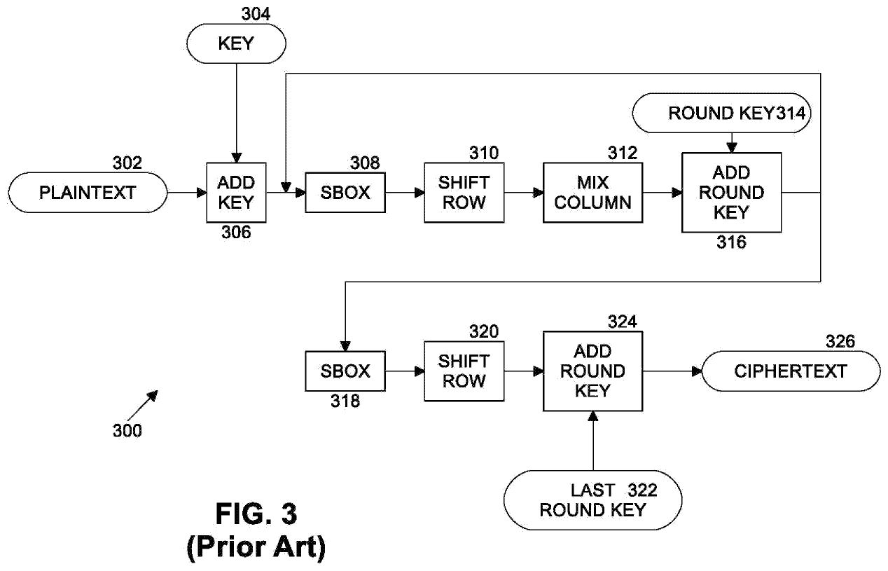

With reference to FIG. 2, an example of an accelerator 220 to perform data processing operations and including encryption circuitry 113 to perform encryption operations is shown. For example, accelerator 220 may be part of computing system 100 along with processor 111.

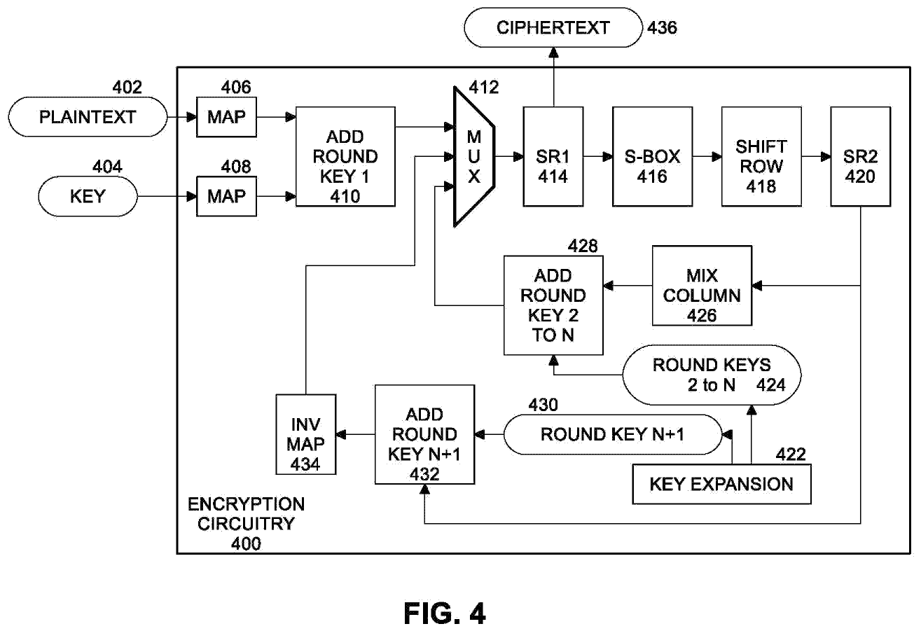

FIG. 3 is a prior art example of AES-256 encryption circuitry 300. AES-256 encryption includes 14 rounds, which operate on a 128-bit plaintext 302 data block and a key 304 of 256 bits. The first 13 rounds are identical, whereas the last round omits a Mix Column step. The internal operations are performed on a granularity of eight bits. For example, the S-box (also known as a Byte Sub) is defined over 8-bit numbers. The S-box implements Galois Field (GF) inversion over GF(2⁸), which is computationally intensive. Similarly, the Mix Column step consists of GF(2⁸) multiplication operations. In general, the round function of AES-256 encryption requires a significant number of arithmetic operations, which is a bottleneck for designing AES-256 encryption circuitry that can operate at very high operating clock speed.

A 128-bit block of plaintext 302 is combined with the 128 most significant bits of a 256-bit input key 304 by Add Key 306. The result is input to S-box 308. The output of S-box 308 is input to Shift Row 310. The output of Shift Row 310 is input to Mix Column 312. A round key 314 is combined with the output of Mix Column 312 by Add Round Key 316. The processing of S-box 308, Shift Row 310, Mix Column 312, and Add Round Key 316 are repeated for another twelve rounds. On the last (e.g., 14^{th} round), S-box 318, Shift Row 320 and Add Round Key 324 (using last round key 322) are performed in sequence to generate 128 bits of ciphertext 326.

In an implementation, the AES S-box in an optimized GF((2⁴)²) provides the most area efficient design that supports up to an approximately 4.5 Ghz operating clock on 10 nm process technology. In other implementations, the S-box may be implemented with a table lookup that will support a higher operating clock but at the cost of higher area. However, it is not currently feasible to implement an entire AES-256 round function including S-box, Mix Column and Add Round Key (also known as Key XOR) within one cycle of a 4.5 GHz clock. Therefore, in an implementation the S-box may be implemented in an area-optimized way that supports up to an approximately 4.5 GHz operating clock. The remaining logic operations (e.g., Mix Column and Add Round Key) are processed in the following clock cycle. Note that the Shift Row step only shuffles bytes within the AES state, which does not involve any logic operation.

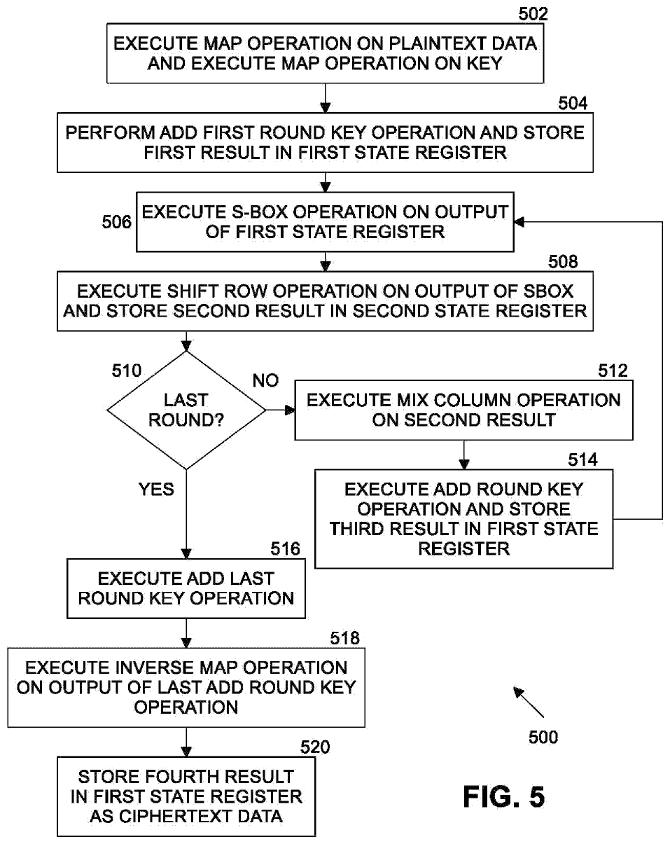

FIG. 4 illustrates encryption circuitry 400 in an implementation. Encryption circuitry 400 is an instance of encryption circuitry 113 of FIGS. 1 and 2. In an implementation, the transformation/mapping of each input 128-bit plaintext block is precomputed, the input 256-bit key is mapped from GF(2⁸) to GF((2⁴)²), and the input key is XOR'ed with the plaintext before loading the first input to a first state register. In the first clock cycle, the S-box and Shift Row steps are performed. The result of the first clock cycle is stored into a second state register SR2. In the second clock cycle, the Mix Column and Add Round Key steps are executed. The result of the second clock cycle is stored back to the first state register and this processing is repeated for the following rounds (e.g., rounds 2 through N−1, where N is 14 for AES).

In an implementation, two AES-256 encryptions are computed concurrently in a pipelined manner. In the first clock cycle, the first state register is loaded with the next plaintext block after precomputation. In the second clock cycle, the first part of encryption circuitry 400 executes the S-box and Shift Row steps on the next plaintext block while the second half of the encryption circuitry executes the Mix Column and Add Round Key steps on the current plaintext block. This processing is repeated 13 times (e.g., for AES-256 with 14 rounds). Then for the last round, as there is no Mix Column step, the second half of the encryption circuitry executes the Add Round Key and the Inverse Mapping (e.g., converting back from GF((2⁴)²) to GF(2⁸)) steps.

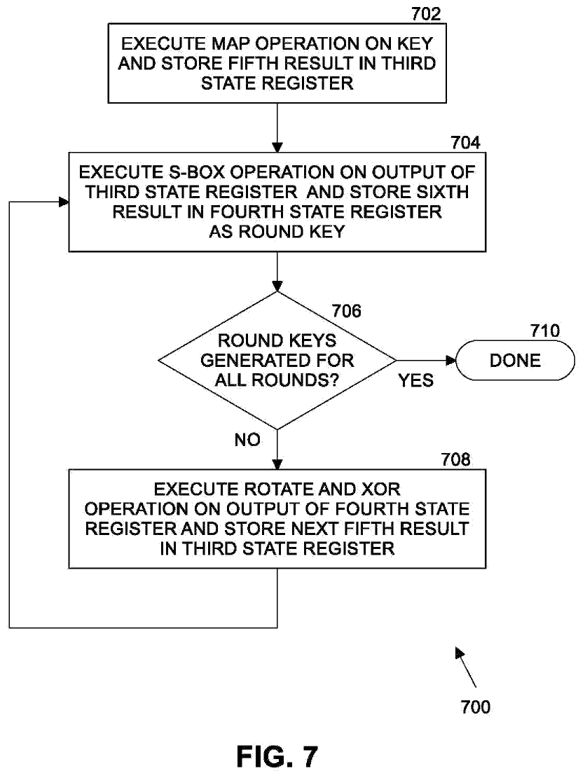

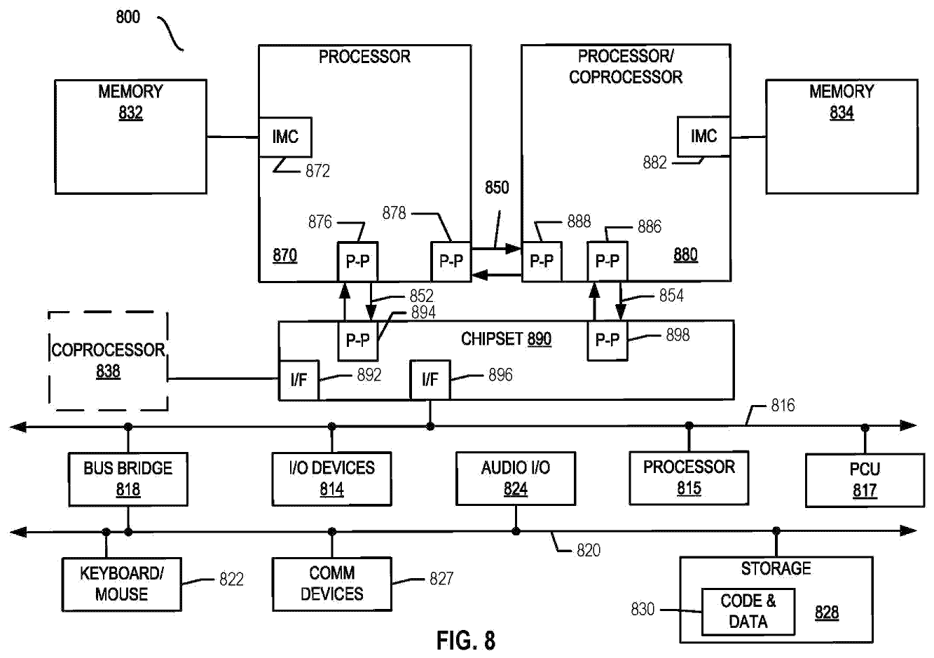

A block of 128 bits of plaintext 402 is input to Map 406 (e.g., to convert from GF(2⁸) to GF((2⁴)²) and 256-bit key 404 is input to Map 408. The mapped plaintext block and the mapped key are input to Add Round Key 1 410. Add Round Key 1 410 combines (e.g., using an XOR function) the mapped plaintext block and the mapped key). The result of Add Round Key 1 410 (e.g., the first result) is selected by multiplexer (MUX) 412 and stored in first state register (SR1) 414. The result is read out of SR1 414 by S-box 416. The output of S-box 416 is input to Shift Row 418. The result of Shift Row 418 (e.g., the second result) is stored in second state register (SR2) 420. For rounds 1 through N−1, where N is 14 for AES, the second result is read out of SR2 420 and input to Mix Column 426. The output of Mix Column 426 is input to Add Round Key 2 to N 428 along with a round key from the set of round keys 1 to N−1 as provide by key expansion circuitry 422 to be combined into a third result (e.g., using an XOR function). The result of Add Round Key 2 to N 428 (e.g., the third result) is selected by MUX 412 and stored in SR1 414. Processing continues with the next round at S-Box 416. For the last round (e.g., round 14 for AES), the second result is read out of SR2 420 and input to Add Round Key N+1 432 along with the last round key (round key N 430) to be combined into a fourth result (e.g., using an XOR function). The result of Add Round Key N+1 432 is input to inverse (Inv) map 434. The result of inverse map 434 (e.g., the fourth result) is selected by MUX 412 and stored in SR1 414. This last result may be read out of SR1 414 as a block of ciphertext 436. Round keys may be generated in parallel by key expansion circuitry 422 as described below with reference to FIGS. 6 and 7.

In an implementation, state registers update at a specific edge (positive, negative) of a clock (not shown) of computing system 100. Components of encryption circuitry 400 from one register to the next are combinatorial, so inputs flow to the outputs instantaneously. Within one register to the next register path, combinatorial blocks are processed in series, one after the next. For example, in FIG. 4, operations of S-Box 416 followed by operations of Shift Row 418 are executed on the SR1 414 output through back-to-back combinatorial circuits and the result is stored in SR2 420 in the following clock edge.

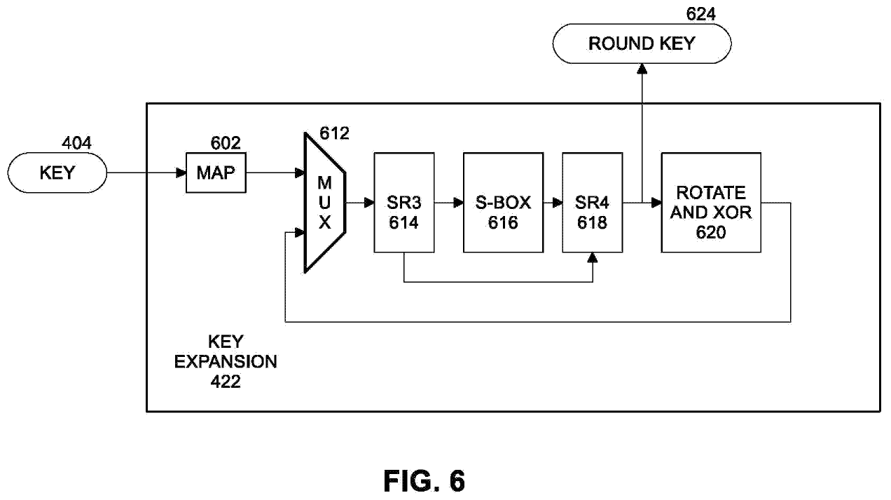

FIG. 5 illustrates encryption processing 500 in an implementation. In an implementation, the steps shown in FIG. 5 are executed by encryption circuitry 400. At block 502, map 406 executes a map operation on plaintext 402 and map 408 executes the map operation on key 404. At block 504, Add Round Key 1 410 (e.g., a first Add Round Key) executes a first Add Round Key operation using the mapped plaintext and mapped key and stores a first result generated by Add Round Key 1 410 (e.g., using an XOR function) in first state register (SR1) 414. At block 506, S-box 416 executes an S-box operation on the output of the first state register (SR1) 414 to generate S-box output data. At block 508, Shift Row 418 executes a Shift Row operation on the output of the S-box (S-box output data) and stores the result, known herein as a second result, generated by the Shift Row operation in second state register (SR2) 420. At block 510, encryption circuitry 400 determines if the current round of encryption processing is the last round for processing the current block of plaintext 402. If not (e.g., for a first round through a next to last round), then at block 512 Mix Column 426 executes a Mix Column operation on the second result (read from SR2 420) to generate Mix Column output data. At block 514, Add Round Key 2 to N 428 (e.g., a subsequent Add Round Key for subsequent rounds other than the last round) executes an Add Round Key operation on the Mix Column output data and a subsequent round key from the set of round keys 2 to N 424 for the current round (as generated in parallel by key expansion circuitry 422). The result of the Add Round Key 2 to N 428 (e.g., herein the third result) is selected by MUX 412 and stored in the first state register (SR1) 414 for use in processing of the next round. At block 510, if this is the last round, then at block 516, Add Round Key N+1 432 (e.g., the last Add Round Key) executes an Add Round Key operation for the last round key (e.g., round key N) and the output of SR2 420 (e.g., the second result) to generate last Add Round Key output data. At block 518, inverse map 434 executes an inverse map operation on the last Add Round Key output data (that is, from the last Add Round Key operation for the current block of plaintext 402) to generate a fourth result. The inverse mapping result is selected by MUX 412 and the fourth result is stored in first state register (SR1) 414. The fourth result may be read from SR1 414 as a block of ciphertext 436.

Thus, during initialization of encryption circuitry 400, map 406, map 408 and Add Round key 1 410 are executed. After initialization, encryption circuitry 400 executes 13 iterations (rounds) of processing (that is, the first round to the round before the last round). In a first clock cycle of each of the 13 iterations, encryption circuitry 400 executes the S-box operation on the first result to generate S-box output data and executes the Shift Row operation on the S-box output data and store the second result generated by executing the Shift Row operation in the second state register. In a second clock cycle of each of the 13 iterations, encryption circuitry 400 executes the Mix Column operation on the second result to generate Mix Column output data, executes the subsequent Add Round Key operation on the Mix Column output data and the subsequent round key to generate the third result, and stores the third result in the first state register. For the last iteration (last round), in a first clock cycle encryption circuitry 400 executes the S-box operation on the first result to generate S-box output data and executes the Shift Row operation on the S-box output data and store the second result generated by executing the Shift Row operation in the second state register. In a second clock cycle of the last iteration, encryption circuitry 400 executes the last Add Round Key operation on the second result and the last round key to generate the third result, and stores the third result in the first state register.

FIG. 6 illustrates key expansion circuitry 422 in an implementation. In an implementation, key expansion circuitry 422 runs in parallel with the round data path shown in FIG. 4 and produces the round keys required for processing the round data path. That is, for the second round through the next to last round, and the last round, key expansion circuitry generates a different (subsequent or last) round key. Key expansion circuitry 422 computes S-box operations on only one 32-bit word followed by a set of rotate and XORs to derive the next 128-bit round key. In an implementation, the data path is broken into two halves and run in two cycles synchronously with the round data path so that each new (e.g., subsequent or last) round key is computed before the round key is required by the round data path blocks of FIG. 4.

A 256-bit key 404 is input to Map 602. The mapped key (known as the fifth result herein) is selected by multiplexer (MUX) 612 and stored in third state register (SR3) 614. The least significant 32 bits of the fifth result is read out of SR3 614 by S-box 616, with the remaining 224 most significant bits of the first result passing directly to SR4 618. The output of S-box 616 is stored in fourth state register (SR4) 618 as a sixth result. This sixth result is a round key 624 (e.g., the first iteration of key expansion circuitry 422 produces round key 2, subsequent iterations produce one of round keys 3 to N 424 or round key N+1 430). Rotate and XOR 620 reads the sixth result from SR4 618 and executes a Rotate and XOR operation. The output of Rotate and XOR 620 is selected by MUX 612 and stored in SR3 614 as a next fifth result for processing of the next round key.

FIG. 7 illustrates key expansion processing 700 in an implementation. In an implementation, the steps shown in FIG. 7 are executed by key expansion circuitry 422. At block 702, Map 602 executes a map operation on key 404 and stores the output of the Map operation as a fifth result in the third state register (SR3) 613 (via MUX 612). At block 704, S-box 616 executes an S-box operation on the output of the third state register (SR3) 614 (e.g., the fifth result) and stores a sixth result in fourth state register (SR4) 618. The sixth result may be read out of SR4 618 as round key 624. At block 706, if round keys have been generated for all rounds (except the initial round generated by Add Round Key 1 410) (e.g., rounds 2 to N, where N is 14 for AES), then key expansion processing is done at block 710. If not, at block 708, Rotate and XOR 620 executes a Rotate and XOR operation on the output of the fourth state register (SR4) 618 (e.g., the sixth result) and stores the result of the Rotate and XOR operation as the next fifth result (e.g., for the next round) in the third state register (SR3) 614 via MUX 612. Key expansion processing continues with generation of the next round key at block 704.

In an implementation, encryption circuitry 113 can meet a 4.5 GHz clock target in a processor made with 10 nm technology with as few as 6,145 combinatorial cells and 823 sequential cells. The design results in a latency of 29 clock cycles from first input to the corresponding output. However, encryption circuitry 113 accepts two encryption requests in back-to-back cycles and produces the respective two AES-256 outputs in 30 cycles, resulting in an example throughput of approximately 384 gigabits per second (Gbps).

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous.

Processors 870 and 880 are shown including integrated memory controller (IMC) units circuitry 872 and 882, respectively. Processor 870 also includes as part of its interconnect controller units point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via a high-performance interface 892. In some examples, the coprocessor 838 is a special-purpose processor, such as, for example, a high-throughput processor, a network or communication processor, compression engine, graphics processor, general purpose graphics processing unit (GPGPU), embedded processor, or the like.

A shared cache (not shown) may be included in either processor 870, 880 or outside of both processors, yet connected with the processors via P-P interconnect, such that either or both processors' local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be a disk drive or other mass storage device which may include instructions/code and data 830, in some examples. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 9 illustrates a block diagram of an example processor 900 that may have more than one core and an integrated memory controller. The solid lined boxes illustrate a processor 900 with a single core 902A, a system agent 910, a set of one or more interconnect controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, bipolar complementary metal oxide semiconductor (CMOS) (BiCMOS), CMOS, or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902(A)-(N).

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous or heterogeneous in terms of architecture instruction set architecture (ISA); that is, two or more of the cores 902(A)-(N) may be capable of executing the same ISA, while other cores may be capable of executing only a subset of that ISA or a ISA.

### Exemplary Core Architectures—In-Order and Out-of-Order Core Block Diagram

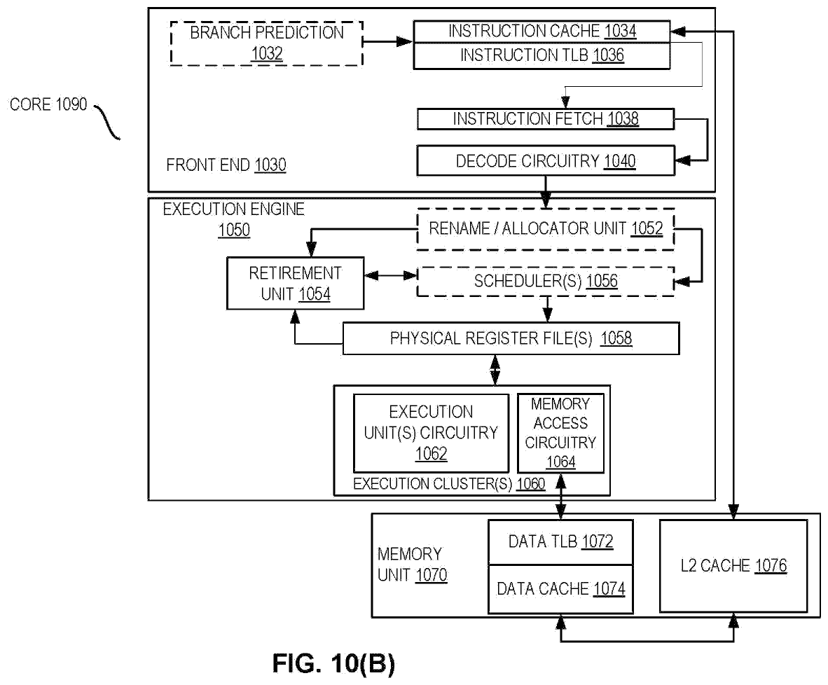

FIG. 10(A) is a block diagram illustrating both an exemplary in-order pipeline and an exemplary register renaming, out-of-order issue/execution pipeline according to examples. FIG. 10(B) is a block diagram illustrating both an exemplary example of an in-order architecture core and an exemplary register renaming, out-of-order issue/execution architecture core to be included in a processor according to examples. The solid lined boxes in FIGS. 10(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10(A), a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution core architecture may implement the pipeline 1000 as follows: 1) the instruction fetch 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10(B) shows processor core 1090 including front-end unit circuitry 1030 coupled to an execution engine unit circuitry 1050, and both are coupled to a memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction circuitry 1032 coupled to an instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include an address generation unit circuitry (AGU, not shown). In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is overlapped by the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to a data cache circuitry 1074 coupled to a level 2 (L2) cache circuitry 1076. In one exemplary example, the memory access circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to a level 2 (L2) cache circuitry 1076 in the memory unit circuitry 1070. In one example, the instruction cache 1034 and the data cache 1074 are combined into a single instruction and data cache (not shown) in L2 cache circuitry 1076, a level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (with some extensions that have been added with newer versions); the MIPS instruction set architecture; the ARM instruction set architecture (with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Exemplary Execution Unit(s) Circuitry

FIG. 11 illustrates examples of execution unit(s) circuitry, such as execution unit(s) circuitry 1062 of FIG. 10(B). As illustrated, execution unit(s) circuitry 1062 may include one or more ALU circuits 1101, vector/single instruction multiple data (SIMD) circuits 1103, load/store circuits 1105, and/or branch/jump circuits 1107. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. Floating-point unit (FPU) circuits 1109 perform floating-point arithmetic. The width of the execution unit(s) circuitry 1062 varies depending upon the example and can range from 16-bit to 1,024-bit. In some examples, two or more smaller execution units are logically combined to form a larger execution unit (e.g., two 128-bit execution units are logically combined to form a 256-bit execution unit).

### Exemplary Register Architecture

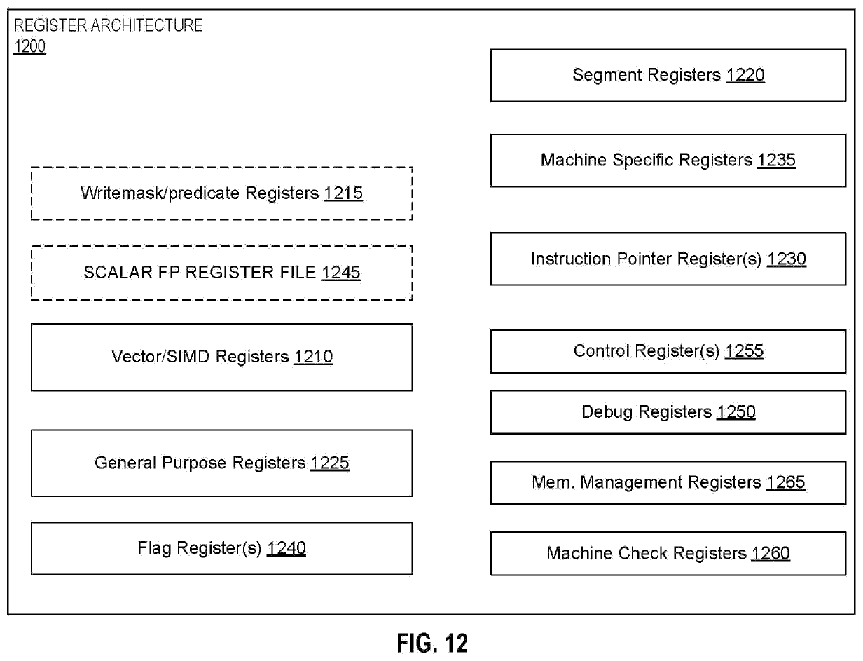

FIG. 12 is a block diagram of a register architecture 1200 according to some examples. As illustrated, there are vector/SIMD registers 1210 that vary from 128-bit to 1,024 bits width. In some examples, the vector/SID registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a GDTR, IDRT, task register, and a LDTR register.

Alternative examples may use wider or narrower registers. Additionally, alternative examples may use more, less, or different register files and registers.

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.)

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

### Examples

Example 1 is an apparatus including first map circuitry to execute a map operation on plaintext data; second map circuitry to execute the map operation on an input key; first Add Round Key circuitry to combine the mapped plaintext data and mapped input key into a first result and store the first result in a first state register; S-box circuitry to generate S-box output data from the first result; Shift Row circuitry to generate a second result from the S-box output data and store the second result in a second state register; Mix Column circuitry and second Add Round Key circuitry to, for a second round through a round before last round, execute a Mix Column operation by the Mix Column circuitry on the second result to generate Mix Column output data, execute a subsequent Add Round Key operation on the Mix Column output data and a subsequent round key by the second Add Round Key circuitry to generate a third result, and store the third result in the first state register; and third Add Round Key circuitry and inverse map circuitry to, for a last round, execute a last Add Round Key operation on the second result and a last round key by the third Add Round Key circuitry to generate last Add Round Key output data, execute an inverse map operation on the last Add Round Key output data by the inverse map circuitry to generate a fourth result, and store the fourth result in the first state register.

In Example 2, the subject matter of Example 1 may optionally include the S-box circuitry to generate the S-box output data and the Shift Row circuitry to generate and store the second result, in a first clock cycle of a round; and the Mix Column circuitry and second Add Round Key circuitry to, for the second round through the round before last round, generate the Mix Column output data by the Mix Column circuitry, generate the third result by the second Add Round Key circuitry, and store the third result in the first state register in a second clock cycle of the round. In Example 3, the subject matter of Example 1 may optionally include the S-box circuitry to generate the S-box output data and the Shift Row circuitry to generate and store the second result, in a first clock cycle of a last round; and the third Add Round Key circuitry and the inverse map circuitry to, for the last round, generate the last Add Round Key output data by the third Add Round Key circuitry, generate the fourth result by the inverse map circuitry, and store the fourth result in the first state register in a second clock cycle of the last round. In Example 4, the subject matter of Example 1 may optionally include wherein the fourth result comprises ciphertext data resulting from encrypting the plaintext data. In Example 5, the subject matter of Example 4 may optionally include wherein the ciphertext data is encrypted with an Advanced Encryption Standard (AES) process.

In Example 6, the subject matter of Example 1 may optionally include the apparatus to repeat execution of the S-box circuitry and execution of the Shift Row circuitry for all rounds. In Example 7, the subject matter of Example 1 may optionally include key expansion circuitry to generate a different subsequent round key for the second round through the round before the last round and generate a last round key for the last round. In Example 8, the subject matter of Example 7 may optionally include wherein the key expansion circuitry includes third map circuitry to generate a fifth result from the input key and store the fifth result in a third state register; and second S-box circuitry to generate a sixth result from on an output of the third state register and store the sixth result in a fourth state register as one of the different subsequent round keys for the second round through the last round and the last round key. In Example 9, the subject matter of Example 8 may optionally include rotate and exclusive-OR (XOR) circuitry to generate the fifth result from an output of the fourth state register and store the fifth result in the third state register. In Example 10, the subject matter of Example 9 may optionally include the key expansion circuitry to repeat execution of the rotate and XOR circuitry to generate the fifth result and store the fifth result in the third state register, and execution of the S-box circuitry to generate the sixth result and store the sixth result in a fourth state register, for the second round through the last round.

Example 11 is a method including executing a map operation on plaintext data; executing the map operation on an input key; executing a first Add Round Key operation using the mapped plaintext data and mapped input key and storing a first result generated by executing the first Add Round Key operation in a first state register; executing an S-box operation on the first result to generate S-box output data; executing a Shift Row operation on the S-box output data and storing a second result generated by executing the Shift Row operation in a second state register; for a second round through a round before last round, executing a Mix Column operation on the second result to generate Mix Column output data, executing a subsequent Add Round Key operation on the Mix Column output data and a subsequent round key to generate a third result, and storing the third result in the first state register; and for a last round, executing a last Add Round Key operation on the second result and a last round key to generate last Add Round Key output data, executing an inverse map operation on the last Add Round Key output data to generate a fourth result, and storing the fourth result in the first state register.

In Example 12, the subject matter of Example 11 may optionally include executing the S-box operation on the first result to generate S-box output data and executing the Shift Row operation on the S-box output data and storing the second result generated by executing the Shift Row operation in the second state register, in a first clock cycle of a round of an encryption circuitry; and for the second round through the round before the last round, executing the Mix Column operation on the second result to generate the Mix Column output data, executing the subsequent Add Round Key operation on the Mix Column output data and the subsequent round key to generate the third result, and storing the third result in the first state register in a second clock cycle of a round of the encryption circuitry. In Example 13, the subject matter of Example 11 may optionally include executing the S-box operation on the first result to generate S-box output data and executing the Shift Row operation on the S-box output data and storing the second result generated by executing the Shift Row operation in the second state register, in a first clock cycle of a last round of an encryption circuitry; and for the last round, executing a last Add Round Key operation on the second result and a last round key to generate last Add Round Key output data, executing an inverse map operation on the last Add Round Key output data to generate a fourth result, and storing the fourth result in the first state register in a second clock cycle of the last round of the encryption circuitry. In Example 14, the subject matter of Example 11 may optionally include wherein the fourth result comprises ciphertext data resulting from encrypting the plaintext data. In Example 15, the subject matter of Example 14 may optionally include wherein the ciphertext data is encrypted with an Advanced Encryption Standard (AES) process.

In Example 16, the subject matter of Example 11 may optionally include repeating executing the S-box operation and executing the Shift Row operation for all rounds. In Example 17, the subject matter of Example 11 may optionally include generating a different subsequent round key for the second round through the round before the last round and generating a last round key for the last round. In Example 18, the subject matter of Example 17 may optionally include wherein generating a different subsequent round key and the last round key includes executing a map operation on the input key to generate a fifth result and storing the fifth result in a third state register; and executing a S-box operation on an output of the third state register to generate a sixth result and storing the sixth result in a fourth state register as one of the different subsequent round keys for the second round through the last round and the last round key. In Example 19, the subject matter of Example 18 may optionally include executing a rotate and exclusive-OR (XOR) operation on an output of the fourth state register to generate a fifth result and storing the fifth result in the third state register. In Example 20, the subject matter of Example 19 may optionally include repeating executing the rotate and exclusive-OR (XOR) operation on the output of the fourth state register to generate the fifth result and storing the fifth result in the third state register, and executing the S-box operation to generate the sixth result and storing the sixth result in a fourth state register, for the second round through the last round.

Example 21 is a system including a memory to store plaintext data and an input key; and encryption circuitry to encrypt the plaintext data into ciphertext data using the input key, the encryption circuitry including first map circuitry to execute a map operation on the plaintext data; second map circuitry to execute the map operation on the input key; first Add Round Key circuitry to combine the mapped plaintext data and mapped input key into a first result and store the first result in a first state register; S-box circuitry to generate S-box output data from the first result; Shift Row circuitry to generate a second result from the S-box output data and store the second result in a second state register; Mix Column circuitry and second Add Round Key circuitry to, for a second round through a round before last round, execute a Mix Column operation by the Mix Column circuitry on the second result to generate Mix Column output data, execute a subsequent Add Round Key operation on the Mix Column output data and a subsequent round key by the second Add Round Key circuitry to generate a third result, and store the third result in the first state register; and third Add Round Key circuitry and inverse map circuitry to, for a last round, execute a last Add Round Key operation on the second result and a last round key by the third Add Round Key circuitry to generate last Add Round Key output data, execute an inverse map operation on the last Add Round Key output data by the inverse map circuitry to generate a fourth result, and store the fourth result in the first state register.

In Example 22, the subject matter of Example 21 may optionally include the S-box circuitry to generate the S-box output data and the Shift Row circuitry to generate and store the second result, in a first clock cycle of a round; and the Mix Column circuitry and second Add Round Key circuitry to, for the second round through the round before last round, generate the Mix Column output data by the Mix Column circuitry, generate the third result by the second Add Round Key circuitry, and store the third result in the first state register in a second clock cycle of the round. In Example 23, the subject matter of Example 121 may optionally include the S-box circuitry to generate the S-box output data and the Shift Row circuitry to generate and store the second result, in a first clock cycle of a last round; and the third Add Round Key circuitry and the inverse map circuitry to, for the last round, generate the last Add Round Key output data by the third Add Round Key circuitry, generate the fourth result by the inverse map circuitry, and store the fourth result in the first state register in a second clock cycle of the last round. In Example 24, the subject matter of Example 21 may optionally include wherein the fourth result comprises ciphertext data resulting from encrypting the plaintext data.

Example 25 is an apparatus operative to perform the method of any one of Examples 11 to 20. Example 26 is an apparatus that includes means for performing the method of any one of Examples 11 to 20. Example 27 is an apparatus that includes any combination of modules and/or units and/or logic and/or circuitry and/or means operative to perform the method of any one of Examples 11 to 20. Example 28 is an optionally non-transitory and/or tangible machine-readable medium, which optionally stores or otherwise provides instructions that if and/or when executed by a computer system or other machine are operative to cause the machine to perform the method of any one of Examples 11 to 20.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
first map circuitry to execute a map operation on plaintext data;
second map circuitry to execute the map operation on an input key;
first Add Round Key circuitry to combine the mapped plaintext data and mapped input key into a first result and store the first result in a first state register;
S-box circuitry to generate S-box output data from the first result;
Shift Row circuitry to generate a second result from the S-box output data and store the second result in a second state register;
Mix Column circuitry and second Add Round Key circuitry to, for a second round through a round before last round, execute a Mix Column operation by the Mix Column circuitry on the second result to generate Mix Column output data, execute a subsequent Add Round Key operation on the Mix Column output data and a subsequent round key by the second Add Round Key circuitry to generate a third result, and store the third result in the first state register; and
third Add Round Key circuitry and inverse map circuitry to, for a last round, execute a last Add Round Key operation on the second result and a last round key by the third Add Round Key circuitry to generate last Add Round Key output data, execute an inverse map operation on the last Add Round Key output data by the inverse map circuitry to generate a fourth result, and store the fourth result in the first state register.

2. The apparatus of claim 1, comprising:
the S-box circuitry to generate the S-box output data and the Shift Row circuitry to generate and store the second result, in a first clock cycle of a round; and
the Mix Column circuitry and second Add Round Key circuitry to, for the second round through the round before last round, generate the Mix Column output data by the Mix Column circuitry, generate the third result by the second Add Round Key circuitry, and store the third result in the first state register in a second clock cycle of the round.

3. The apparatus of claim 1, comprising:
the S-box circuitry to generate the S-box output data and the Shift Row circuitry to generate and store the second result, in a first clock cycle of a last round; and
the third Add Round Key circuitry and the inverse map circuitry to, for the last round, generate the last Add Round Key output data by the third Add Round Key circuitry, generate the fourth result by the inverse map circuitry, and store the fourth result in the first state register in a second clock cycle of the last round.

4. The apparatus of claim 1, wherein the fourth result comprises ciphertext data resulting from encrypting the plaintext data.

5. The apparatus of claim 4, wherein the ciphertext data is encrypted with an Advanced Encryption Standard (AES) process.

6. The apparatus of claim 1, comprising the apparatus to repeat execution of the S-box circuitry and execution of the Shift Row circuitry for all rounds.

7. The apparatus of claim 1, comprising key expansion circuitry to generate a different subsequent round key for the second round through the round before the last round and generate a last round key for the last round.

8. The apparatus of claim 7, wherein the key expansion circuitry comprises:
third map circuitry to generate a fifth result from the input key and store the fifth result in a third state register; and
second S-box circuitry to generate a sixth result from on an output of the third state register and store the sixth result in a fourth state register as one of the different subsequent round keys for the second round through the last round and the last round key.

9. The apparatus of claim 8, comprising rotate and exclusive-OR (XOR) circuitry to generate the fifth result from an output of the fourth state register and store the fifth result in the third state register.

10. The apparatus of claim 9, comprising the key expansion circuitry to repeat execution of the rotate and XOR circuitry to generate the fifth result and store the fifth result in the third state register, and execution of the S-box circuitry to generate the sixth result and store the sixth result in a fourth state register, for the second round through the last round.

11. A method comprising:
executing a map operation on plaintext data;
executing the map operation on an input key;
executing a first Add Round Key operation using the mapped plaintext data and mapped input key and storing a first result generated by executing the first Add Round Key operation in a first state register;
executing an S-box operation on the first result to generate S-box output data;
executing a Shift Row operation on the S-box output data and storing a second result generated by executing the Shift Row operation in a second state register;
for a second round through a round before last round, executing a Mix Column operation on the second result to generate Mix Column output data, executing a subsequent Add Round Key operation on the Mix Column output data and a subsequent round key to generate a third result, and storing the third result in the first state register; and
for a last round, executing a last Add Round Key operation on the second result and a last round key to generate last Add Round Key output data, executing an inverse map operation on the last Add Round Key output data to generate a fourth result, and storing the fourth result in the first state register.

12. The method of claim 11, comprising:
executing the S-box operation on the first result to generate S-box output data and executing the Shift Row operation on the S-box output data and storing the second result generated by executing the Shift Row operation in the second state register, in a first clock cycle of a round of an encryption circuitry; and
for the second round through the round before the last round, executing the Mix Column operation on the second result to generate the Mix Column output data, executing the subsequent Add Round Key operation on the Mix Column output data and the subsequent round key to generate the third result, and storing the third result in the first state register in a second clock cycle of a round of the encryption circuitry.

13. The method of claim 11, comprising:
executing the S-box operation on the first result to generate S-box output data and executing the Shift Row operation on the S-box output data and storing the second result generated by executing the Shift Row operation in the second state register, in a first clock cycle of a last round of an encryption circuitry; and
for the last round, executing a last Add Round Key operation on the second result and a last round key to generate last Add Round Key output data, executing an inverse map operation on the last Add Round Key output data to generate a fourth result, and storing the fourth result in the first state register in a second clock cycle of the last round of the encryption circuitry.

14. The method of claim 13, wherein the fourth result comprises ciphertext data resulting from encrypting the plaintext data.

15. The method of claim 11, comprising generating a different subsequent round key for the second round through the round before the last round and generating a last round key for the last round.

16. The method of claim 15, wherein generating a different subsequent round key and the last round key comprises:
executing a map operation on the input key to generate a fifth result and storing the fifth result in a third state register; and
executing a S-box operation on an output of the third state register to generate a sixth result and storing the sixth result in a fourth state register as one of the different subsequent round keys for the second round through the last round and the last round key.

17. The method of claim 16, comprising executing a rotate and exclusive-OR (XOR) operation on an output of the fourth state register to generate a fifth result and storing the fifth result in the third state register.

18. A system comprising:
a memory to store plaintext data and an input key; and
encryption circuitry to encrypt the plaintext data into ciphertext data using the input key, the encryption circuitry including:
first map circuitry to execute a map operation on the plaintext data;
second map circuitry to execute the map operation on the input key;
first Add Round Key circuitry to combine the mapped plaintext data and mapped input key into a first result and store the first result in a first state register;
S-box circuitry to generate S-box output data from the first result;
Shift Row circuitry to generate a second result from the S-box output data and store the second result in a second state register;
Mix Column circuitry and second Add Round Key circuitry to, for a second round through a round before last round, execute a Mix Column operation by the Mix Column circuitry on the second result to generate Mix Column output data, execute a subsequent Add Round Key operation on the Mix Column output data and a subsequent round key by the second Add Round Key circuitry to generate a third result, and store the third result in the first state register; and
third Add Round Key circuitry and inverse map circuitry to, for a last round, execute a last Add Round Key operation on the second result and a last round key by the third Add Round Key circuitry to generate last Add Round Key output data, execute an inverse map operation on the last Add Round Key output data by the inverse map circuitry to generate a fourth result, and store the fourth result in the first state register.

19. The system of claim 18, comprising:
the S-box circuitry to generate the S-box output data and the Shift Row circuitry to generate and store the second result, in a first clock cycle of a round; and
the Mix Column circuitry and second Add Round Key circuitry to, for the second round through the round before last round, generate the Mix Column output data by the Mix Column circuitry, generate the third result by the second Add Round Key circuitry, and store the third result in the first state register in a second clock cycle of the round.

20. The system of claim 18, comprising:
the S-box circuitry to generate the S-box output data and the Shift Row circuitry to generate and store the second result, in a first clock cycle of a last round; and
the third Add Round Key circuitry and the inverse map circuitry to, for the last round, generate the last Add Round Key output data by the third Add Round Key circuitry, generate the fourth result by the inverse map circuitry, and store the fourth result in the first state register in a second clock cycle of the last round.
